(19) United States
(12) Patent Application Publication
(10) Pub. No.: US 2011/0202733 A1
(43) Pub. Date: Aug. 18, 2011

(54) SYSTEM AND/OR METHOD FOR REDUCING DISK SPACE USAGE AND IMPROVING INPUT/OUTPUT PERFORMANCE OF COMPUTER SYSTEMS

(75) Inventor: Mark D. Wright, Austin, TX (US)

(73) Assignee: NITROSPHERE CORPORATION, Leander, TX (US)

(21) Appl. No.: 13/028,518

(22) Filed: Feb. 16, 2011

Related U.S. Application Data
(63) Continuation of application No. 12/599,401.

(51) Int. Cl. G06F 17/30; G06F 12/10; G06F 12/00

(52) U.S. Cl. 711/154; 711/203; 711/E12.001; 711/E12.058

(57) ABSTRACT

The present invention provides a system and/or method for reducing disk space usage and/or improving I/O performance of a computer system through the use of data compression and mapping of data page blocks to reduced size data file blocks. The system and/or method can be used to intercept activity at an interface of a computer system I/O subsystem and then map logical data page blocks to reduced sized physical file data blocks on a one-to-one basis, utilizing a suitable data compression algorithm. The system and/or method also allows data compression to be reversed when reading data from a physical disk storage medium associated with that computer system. The system may be implemented as either a device driver or a module linked to an I/O module of a computer system.

### CROSS REFERENCE TO RELATED APPLICATIONS

This application claims the priority of U.S. National Stage application Ser. No. 12/599,401, filed on Nov. 9, 2009, which is a National Stage Filing of Patent Cooperation Treaty Application No.: PCT/AU2008/00649 with international filing date of May 9, 2008, which claims priority to Australian Patent Application No.: 2007902482 filed on May 10, 2007.

### FIELD OF THE INVENTION

The present invention relates, generally, to a system and/or method for reducing disk space usage and/or improving input/output performance of computer systems and relates particularly, though not exclusively, to a system and/or method which reduces disk space usage and/or improves input/output (hereinafter simply referred to as “I/O”) performance of computer systems through the use of data compression and mapping of data page blocks to reduced size data file blocks. More particularly, the present invention relates to a system and/or method which can intercept I/O activity at an interface of a computer system I/O subsystem and then map logical data page blocks to reduced sized physical file blocks on a one-to-one basis, utilizing any suitable data compression algorithm. The system and/or method of the present invention may also allow data compression to be reversed when reading data from a physical disk storage medium associated with that computer system.

It will be convenient to hereinafter describe the invention in relation to a software and/or hardware based system and/or method which may be implemented as a device driver and/or a module linked to an I/O module of a computer system, however it should be appreciated that the present invention is not limited to that use only. The system and/or method of the present invention may also be implemented or used in many other ways without departing from the spirit and scope of the invention as hereinafter described. Accordingly, the present invention should not be construed as limited to the specific examples provided herein and described with reference to the drawings.

Throughout the ensuing description the expression “filter driver” is intended to refer to a device driver that sits above another device driver of a computer system to monitor or modify its behavior. The expression “API”, or ‘Application Programming Interface’, is intended to refer to any set of routines used by applications of a computer system to perform some task. Suitable API's include, but are not limited to, the so-called file 110 API's, and graphics API's. Finally, the expression “linked module” is intended to refer to a library (which may be dynamic or shared depending on the operating system) that contains code that will set pointers for operating system API's to code in a linked module. The linked module code mayor may not call the original operating system API's.

### BACKGROUND ART

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure herein.

Computer systems typically use databases and/or other similar types of software for ordering and storing large amounts of data contained on storage mediums or disks. As information or data stored within these types of software applications increases, the amount of disk storage space required also rapidly increases, which can lead to an increase of the cost of ownership and/or management of a computer system or computer network.

Databases typically store data on disks in specialized or proprietary file formats, wherein the fixed block size and physical order of that data must be maintained in order to enable that database to use the inherent structure of the data for retrieval purposes. Any use of standard file compression software or algorithms will render this structure unusable by a database application. So, standard file compression software cannot be utilized for the purpose of disk space reduction of database files.

A need therefore exists for a system and/or method which can be used to compress database files without rendering the structure of those files unusable by database applications.

It is believed that the interception of software I/O activity immediately prior to it entering a computer system I/O subsystem offers an opportunity to compress the page data in the event of a database write operation, or decompress the page data in the event of a database read operation, without impacting on the operation of the original database software. Therefore, a software and/or hardware tool/module linked with the I/O subroutine of a database and/or any other similar type of software and/or hardware application that intercepts I/O activity immediately prior to it entering a computer system I/O subsystem may compress and decompress the data, offering an opportunity to significantly reduce disk space usage.

In addition, disk controller hardware of computer systems often cache data recently accessed in a small amount of memory directly attached to that disk controller hardware, with the objective being to reduce the need to actively retrieve recently utilized data directly from a disk, effectively increasing the speed of some I/O activity. This type of memory is typically known as disk cache memory.

Compression of data prior to entry into a computer I/O system will therefore also result in improved utilization of disk cache memory, as the disk controller hardware will be able to fit more actual data into the disk cache memory than it would if the data was not being compressed. The end result is that any module that compresses/decompresses data prior to entry into a computer I/O system offers an opportunity to improve disk cache memory usage, and as a result thereof, overall system performance.

It is therefore an object of the present invention to provide a system and/or method for reducing disk space usage and/or improving I/O performance of computer systems.

### BRIEF DESCRIPTION OF THE INVENTION

According to one aspect of the present invention there is provided a method for reducing disk space usage and/or improving I/O performance of a computer system, said method including the step of: mapping logical data pages to physical file data blocks of lesser fixed block size on a one-to-one basis in a predetermined ordered manner.

Preferably said step of mapping logical data pages to physical file data blocks of lesser fixed block size on a one-to-one basis in a predetermined ordered manner includes the steps of: intercepting write I/O activity of a database and/or any other suitable application; and, compressing said logical data pages to the size of said physical file data blocks of lesser fixed block size than said logical data pages so that the compressed logical data pages are written into said physical file data blocks. Preferably said step of compressing said logical data pages to the size of said physical file data blocks of lesser fixed block size than said logical data pages is performed utilizing any suitable data compression application or algorithm. It is also preferred that said step of compressing said logical data pages to the size of said physical file data blocks of lesser fixed block size than said logical data pages occurs asynchronously to normal data processing, in order to maintain performance levels for high-speed computer systems.

Preferably said method further includes the step of: writing incompressible logical data pages, or excess compressible logical data pages that could not fit into said physical file data blocks, into an overflow file whilst maintaining logical mapping via the use of pointers.

Preferably said method further includes the steps of: intercepting read I/O of said database and/or any other suitable application; and, decompressing said physical file data blocks of fixed size to logical data pages for return to said database and/or any other suitable application for normal processing.

Preferably said step of decompressing said physical file data blocks of fixed size to logical data pages is performed utilizing any suitable data decompression application or algorithm. It is also preferred that said step of decompressing said physical file data blocks of fixed size to logical data pages occurs asynchronously to normal data processing, in order to maintain performance levels for high-speed computer systems.

Preferably said method is implemented on said computer system as either a software module linked with an I/O subroutine of said database and/or any other suitable application, or as a software device driver in an operating system configured for use with data storage devices connected to, or associated with, said computer system.

In a practical preferred embodiment, said method may be utilized to convert all of the data, or a portion of the data, of fixed block length of a database to a physical file consisting of blocks of reduced size to the original file whilst maintaining the physical order of said blocks. Preferably said portion of said data of said database is defined by individual tables, views, indexes, and/or any other suitable logical or physical partitions of said database.

In a further practical preferred embodiment, said method may be utilized to compress all of the data of a data storage device used by a non-database application of said computer system, or a predefined logical or physical portion of that data storage device.

Preferably said method may be utilized to examine said database and/or said data storage device to determine a suitable compression ratio for same, or to suggest a higher compression ratio for particular logical partitions of said' database and/or said data storage device. It is also preferred that said examination process can also be used to apply a compression ratio to copy an existing database, or portion thereof, to compressed data files with fixed length block sizes equivalent to the original block size reduced by the compression ratio.

According to a further aspect of the present invention there is provided a method for reducing disk space usage and/or improving 110 performance of a computer system, said computer system having a database application installed thereon, said method including the step of: intercepting database write activity to disk consisting of a data page of fixed length; compressing said data page to a size that is a divisor of same; and, passing the compressed data page to an 110 subsystem of said computer system whereat it is then written to a fixed length data file block of the same size as said compressed data page.

Preferably sector alignment is maintained on said disk such that high performance unbuffered 110 can still be used. It is also preferred that the write order of said data file blocks within said database is maintained, as is a one-to one correspondence of compressed data blocks to logical data pages.

Preferably said method further includes the steps of: intercepting database read activity from disk; decompressing said compressed data pages from said fixed length file block size to the data page size; and, passing the decompressed data pages back to said database for normal processing.

According to yet a further aspect of the present invention there is provided a machine readable medium storing a set of instructions that, when executed by a machine, cause the machine to execute a method for reducing disk space usage and/or improving 110 performance of said machine, said method including the step of: mapping logical data pages to physical file data blocks of lesser fixed block size on a one-to-one basis in a predetermined ordered manner.

According to yet a further aspect of the present invention there is provided a machine readable medium storing a set of instructions that, when executed by a machine, cause the machine to execute a method for reducing disk space usage and/or improving I/O performance of said machine, said machine having a database application installed thereon, said method including the steps of: intercepting database write activity to disk consisting of a data page of fixed length; compressing said data page to a size that is a divisor of same; and, passing the compressed data page to an I/O subsystem of said machine whereat it is then written to a fixed length data file block of the same size as said compressed data page.

According to yet a further aspect of the present invention there is provided a computer program including computer program code adapted to perform some or all of the steps of the method as described with reference to anyone of the preceding paragraphs, when said computer program is run on a computer system.

According to yet a further aspect of the present invention there is provided a computer program according to the preceding paragraph embodied on a computer readable medium.

According to yet a further aspect of the present invention there is provided a system for reducing disk space usage and/or improving I/O performance of a computer system, said computer system including at least one memory or storage unit operable to store data therein, and at least one processor operable to execute software that maintains and controls access to said data stored in said at least one memory or storage unit; said system including: means for mapping logical data pages to physical file data blocks of lesser fixed block size on a one-to-one basis in a predetermined ordered manner.

Preferably said means for mapping logical data pages to physical file data blocks of lesser fixed block size on a one-to-one basis in a predetermined ordered manner includes: means for intercepting write 110 activity of a database and/or any other suitable software application; and, means for compressing said logical data pages to the size of said physical file data blocks of lesser fixed block size than said logical data pages so that the compressed logical data pages are written into said physical file data blocks of said at least one memory or storage unit. Preferably said means for compressing said logical data pages to the size of said physical file data blocks of lesser fixed block size than said logical data pages is a suitable data compression software application.

Preferably said system further includes means for writing incompressible logical data pages, or excess compressible logical data pages that could not fit into said physical file data blocks, into an overflow file of said at least one memory or storage unit whilst maintaining logical mapping via the use of pointers.

Preferably said system further includes: means for intercepting read I/O of said database and/or any other suitable software application; and, means for decompressing said physical file data blocks of fixed size to logical data pages for return to said database and/or any other suitable software application for normal processing. Preferably said means for decompressing said physical file data blocks of fixed size to logical data pages is a suitable data decompression software application.

Preferably said means for intercepting write/read I/O activity of said database and/or any other suitable software application is either a software module linked with an I/O subroutine of said database and/or any other suitable software application, or a software device driver in an operating system configured for use with said at least one memory or storage unit of said computer system.

According to yet a further aspect of the present invention there is provided a system for reducing disk space usage and/or improving I/O performance of a computer system, said computer system including at least one memory or storage unit operable to store data therein, and at least one processor operable to execute a database software application that maintains and controls access to said data stored in said at least one memory or storage unit; said system including: means for intercepting database write activity to said at least one memory or storage unit consisting of a data page of fixed length; means for compressing said data page to a size that is a divisor of same; and, means for passing the compressed data page to an I/O subsystem of said computer system whereat it is then written to a fixed length data file block of the same size as said compressed data page on said at least one memory or storage unit.

### ADVANTAGES OF THE INVENTION

Accordingly, the present invention provides a useful system, method and/or computer program for reducing disk space usage and/or improving 110 performance of computer systems through the use of data compression and mapping of data page blocks to reduced size data file blocks.

In its preferred form, the present invention provides a software and/or hardware system which is operable to intercept 110 activity at an interface of a computer system 110 subsystem, and then map logical data page blocks to reduced sized physical file blocks on a one-to-one basis, utilizing a suitable data 15 compression algorithm. The software and/or hardware system of the present invention also allows data compression to be reversed as required when reading data from a physical disk storage medium associated with a computer system.

By intercepting database software 110 activity immediately prior to it entering a computer system I/O subsystem an opportunity becomes available to compress the page data in the event of a database write operation, or decompress the page data in the event of a database read operation, without impacting on the operation of a database application. Therefore, the system and/or method of the present invention enables database files to be compressed and/or decompressed as required, resulting in a significant reduction of disk space usage.

Use of the system and/or method of the present invention for compressing and decompressing database files will also result in improved utilization of disk cache memory in relation to those database files, as the disk controller hardware will be able to fit more data into the disk cache memory than it would if the database data was not being compressed. Therefore, the system and/or method of the present invention also enables overall computer system performance to be improved in relation to I/O activities performed in association with a database application installed thereon.

Any and all patent applications, patents, non-patent-literature, or the like referenced herein are hereby incorporated herein by reference as if fully set forth.

### BRIEF DESCRIPTION OF THE DRAWINGS

In order that the invention may be more clearly understood and put into practical effect there shall now be described in detail preferred constructions of a system and/or method for reducing disk space usage and/or improving I/O performance of computer systems, in accordance with the invention. The ensuing description is given by way of non-limitative example only and is with reference to the accompanying drawings, wherein:

FIG. 1 is a block diagram of a system for reducing disk space usage and/or improving I/O performance of a computer system, made in accordance with a preferred embodiment of the present invention, the system shown implemented as a linked module of a computer system;

FIG. 2 is a block diagram of a system for reducing disk space usage and/or improving I/O performance of a computer system, made in accordance with a second preferred embodiment of the present invention, this time the system is shown implemented as a device driver of a computer system;

FIG. 3 is a block diagram illustrating a method of mapping logical data pages to physical file blocks and an overflow file in accordance with the present invention, the method being suitable for use with the system for reducing disk space usage and/or improving I/O performance of a computer system shown in FIG. 1 or FIG. 2;

FIG. 4 is a flow diagram illustrating one embodiment of a method for compressing data files when write activity is performed on a computer system, the method being suitable for use with the system for reducing disk space usage and/or improving I/O performance of a computer system shown in FIG. 1 or FIG. 2; and,

FIG. 5 is a flow diagram illustrating one embodiment of a method for decompressing data files when read activity is performed on a computer system, the method being suitable for use with the system for reducing disk space usage and/or improving I/O performance of a computer system shown in FIG. 1 or FIG. 2.

### MODES FOR CARRYING OUT THE INVENTION

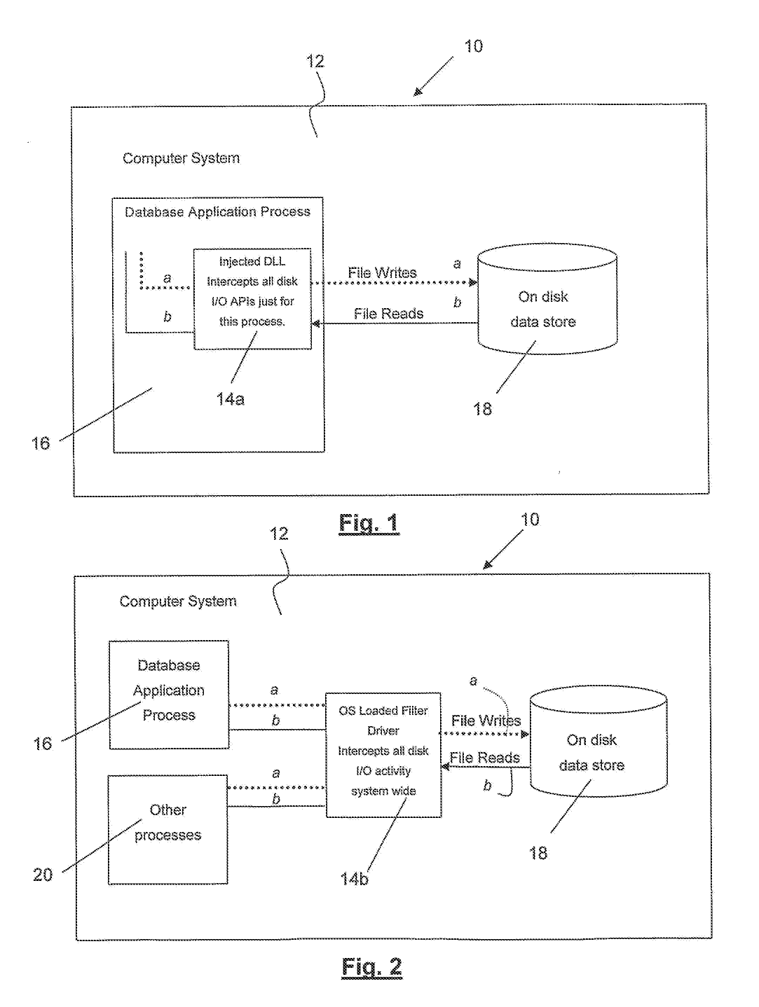

In FIGS. 1 & 2 there is shown a system 10 for reducing disk space usage and/or improving I/O performance of a computer system 12. In a preferred form, system 10 is a software application or program 14 that can be deployed on any suitable computer system 12, such as, for example, a workstation or a computer server. Although described as being a software application, it should be appreciated that system 10 could also be a hardware application, or a combined hardware and software application, that could be installed in/on computer system 12 to achieve the same or similar result. Accordingly, the present invention should not be construed as limited to the specific example provided.

As can be seen in FIGS. 1 & 2, system 10 may be implemented as either a software module 14a, such as, for example, a dynamically linked library or “dll”, linked to an I/O subroutine of a database and/or any other suitable software application 16 (see FIG. 1), or as a software filter driver 14b incorporated within an operating system (not shown) of computer system 12 (see FIG. 2).

In either case, module 14a or filter driver 14b of system 10 are each configured to intercept write/read I/O activity to/from a data storage device 18 associated with computer system 12, as is indicated by dashed line(s) a (write activity) and solid line(s) b (read activity). In the embodiment shown in FIG. 1, module 14a is configured to only intercept database 16 write/read activity to/from data storage device 18. Whilst in FIG. 2, filter driver 14b is configured to intercept any read/write activity to/from data storage device 18, which may be write/read activity of database 16 and/or write/read activity of any other suitable process(es) or application(s) 20 installed on computer system 12.

The interception of write/read activity to/from data storage device 18 provided by module 14a or filter driver 14b of system 10 offers an opportunity to compress data in the event of a write operation (dashed lines a), or decompress data in the event of a read operation (solid lines b), without impacting on the operation of the original database 16 and/or other suitable application 20.

Compression and decompression of data may occur asynchronously to normal processing, in order to maintain performance levels of computer system 12.

Any suitable data compression/decompression algorithm or application (not shown) may be used in accordance with system 10 of the present invention.

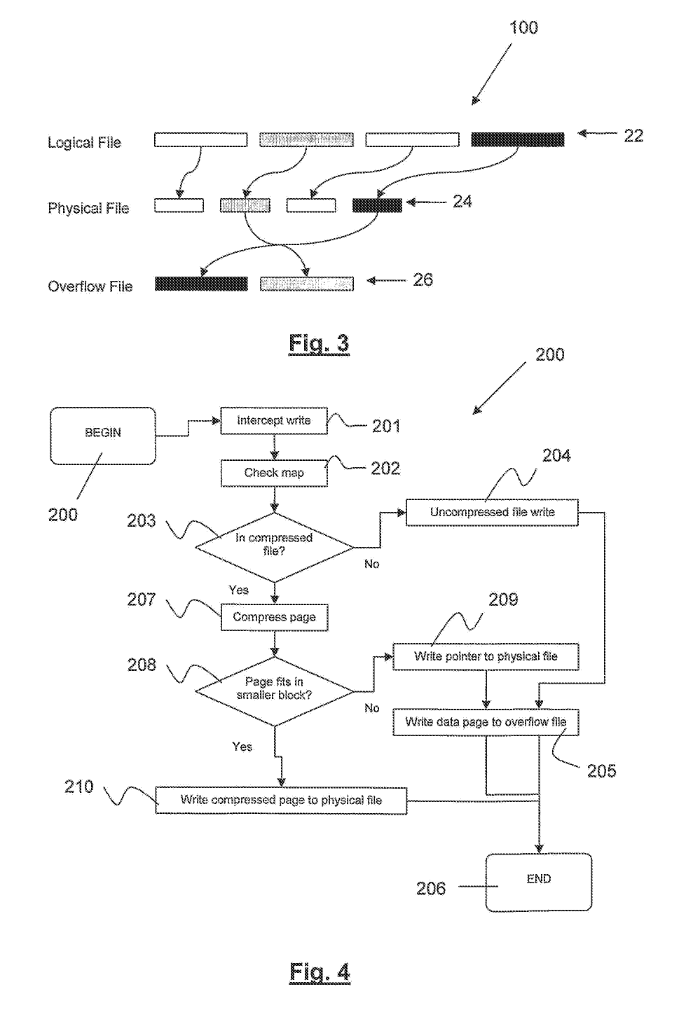

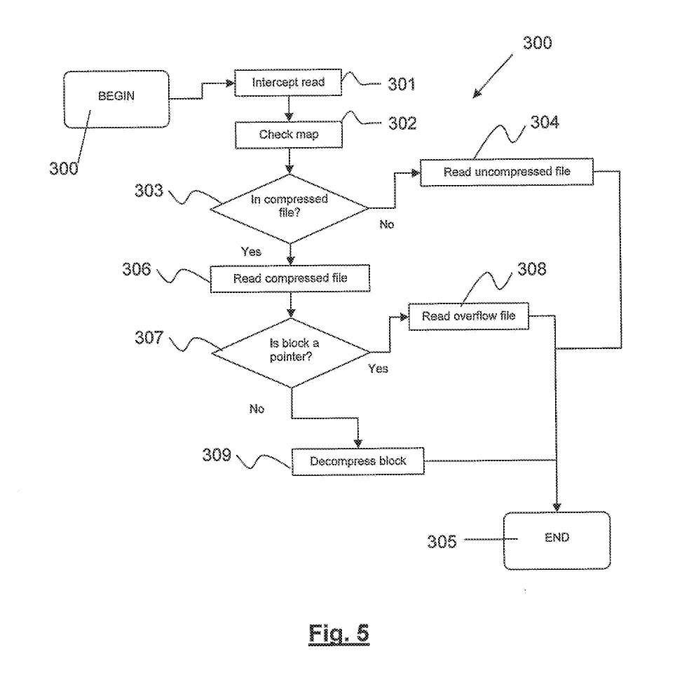

A preferred data compression/decompression method 100 of mapping logical data pages 22 to physical file blocks 24 and an overflow file 26, suitable for use with system 10 of the present invention, is shown in FIG. 3. This method 100 will now be described with reference to FIGS. 4 & 5, wherein in FIG. 4 there is shown a flow diagram illustrating a preferred method 200 for compressing data when write activity a is performed on computer system 12, and wherein in FIG. 5 there is shown a flow diagram illustrating a preferred method 300 for decompressing data when read activity b is performed on computer system 12.

### File Create/Open Operations of System 10:

All file create and open operations of system 10 are intercepted either with filter driver 14b (FIG. 2), or with module 14a (FIG. 1) which redirects API's (not shown) through the software code of system 10 of the present invention. Steps 201,301 of preferred methods 200,300, respectively, illustrate the interception of logical data 22 write/read activity in accordance system 10 of the present invention.

During a file create or open operation, a determination is made as to whether the logical data 22 is a compressible/compressed file (see steps 202,203 & 302,303 of FIGS. 4 & 5), and that handle is either colored with a bit or added to a hash table so that other intercepted APIs or driver operations know how to behave. If a bit is set in the handle, then all file operations must be intercepted to unset the bit for the original APIs. This process can be represented by the following example processing logic.

Example Processing Logic

Handle OpenOrCreate(filename)

Begin
If (filename is in list of compressed files) then begin

Handle = OriginalCreateOrOpenAPI(filename)
If (API interception) then Set High Order bit of handle
Else /* filter driver */ add handle to hash table
End else handle = OriginalCreateOrOpenAPI(filename)

Return handle

End

### File Write Operations of System 10:

As illustrated by step 201 of preferred method 200 of FIG. 4, for filter driver 14b implementation, all write operations are intercepted, whilst for linked module 14a implementation, all write APIs are intercepted. Method 200 can be used for compressing logical data 22 before it is written to data storage device 18, while maintaining sector alignment.

If after intercepting write activity at step 201, it is determined at steps 202,203 that logical data 22 is not a compressible file, logical data 22 is written to overflow file 26 at steps 204,205, wherein thereafter method 200 concludes at step 206. However, if after intercepting write activity at step 201, it is determined at steps 202,203 that logical data 22 is a compressible file, logical data 22 is compressed at step 207. After logical data 22 is compressed at step 207, a determination is made at step 208 as to whether the compressed data page can fit into a space provided within physical data file 24.

If at step 208 it is determined that the compressed data page can fit into physical data file 24, the compressed data page is written to physical data file 24 at step 210, wherein thereafter method 200 concludes at step 206. However, if at step 208 it is determined that the compressed data page cannot fit into physical data file 24, at step 210 only a portion of the compressed data page that can fit into physical data file 24 is written to physical data file 24 at step 210. Method 200 then continues at steps 209 & 205, wherein at step 209 a pointer is set within physical file 24 to indicate that not all the compressed data page is contained within physical data file 24, then the remaining portion of the compressed data page is written to overflow file 26 at step 205. Method 200 then concludes at step 206 as before. Method 200 can also be expressed by the following example processing logic.

Example Processing Logic

Write(handle, data, datalen)

Begin

If handle high bit set or in hash table (filter driver only) then
begin
Compress data
If (compressed length <= ((datalen/2)-pageinfo)) then write
compressed data

Else begin

Write data beyond the cutoff into the overflow file
Write data that can fit into the main file and link to
overflow

End

End else call original write API

End

### File Read Operations of System 10:

As illustrated by step 301 of preferred method 300 of FIG. 5, for filter driver 14b implementation, all read operations are intercepted, whilst for linked module 14a implementation, all read APIs are intercepted. Method 300 can be used for decompressing logical data 22 after it is read from physical file 24 (and/or overflow file 26) and before it is returned to a calling application 16,20 (e.g. a database or other suitable application or process).

If after intercepting read activity at step 301, it is determined at steps 302,303 that logical data 22 is not in a compressed physical file 24, logical data 22 is read from overflow file 26 at step 304, wherein thereafter method 300 concludes at step 305. However, if after intercepting read activity at step 301, it is determined at steps 302,303 that logical data 22 is in a compressed physical file 24, logical data 22 is read from the compressed physical file 24 at step 306. After logical data 22 is read from the compressed physical file 24 at step 306, a determination is made at step 307 as to whether a pointer was set for that physical file 24 (see step 209 of method 200 of FIG. 4) during compression.

If at step 307 it is determined that a pointer was not set for the compressed physical file 24, physical file 24 is decompressed at step 309, resulting in the original logical data 22 being restored and ready to be passed to the calling application 16,20, wherein thereafter method 300 concludes at step 305. However, if at step 307 it is determined that a pointer was set for the compressed physical file 24, at step 309 only the portion of the compressed logical data 22 contained within physical data file 24 is decompressed. Method 300 then continues at step 308, wherein the remaining portion of the compressed logical data 22 is read from overflow file 26 and is decompressed if need be. Method 300 then concludes at step 305 as before. Method 300 can also be expressed by the following example processing logic.

Example Processing Logic

Read(handle, data, datalen)

Begin

If handle high bit set or in hash table (filter driver only) then
begin

Read compressed data from file
If (linked to an overflow file) then read compressed data
from overflow
Uncompress the data

End else call original read API

End

### File Set Position Function of System 10:

When system 10 attempts to set the file position, it is actually asking for a position twice as far out in the file than it actually is. Therefore, this operation (filter driver 14b) or API (linked module 14a) must be intercepted to adjust the position to where the real position is in the file, which is simply half of what is being asked for.

Example Processing Logic

SetFilePosition(handle, position)

Begin

If handle high bit set or in hash table (filter driver only) then
begin

Position = position/2;

End
Call the original SetFilePosition API or lower level driver

End

### Overflow File 26 of System 10:

Overflow file 26 of system 10 contains the compressed data that cannot fit into a slot of physical file 24 that is half the size of the original logical data file 22 after compression. Overflow file 26 itself may be sector aligned for high speed access. Because data can grow over time, if one position in overflow file 26 needs to grow and it isn't at the end of the overflow file 26, additional space is linked to it. Therefore, multiple locations in overflow file 26 may need to be read in order to get all the logical data 22 associated with a request. This dislocated data is referred to as fragmentation. To defeat fragmentation, either a scheduled job will run or at a user request, overflow file 26 can be scanned and reordered such that there is no fragmentation. For the most part, overflow file 26 itself, as well as fragmentation, should be avoided by assuming at most 50% compression of logical data 22. Typically, there will actually be extra room for growth in logical data 22 which may in fact diminish the normal fragmentation that naturally occurs in database 16.

### Conversion of Database 16 or Data Storage Device 18 Utilizing System 10:

System 10 of the present invention may be utilized to compress an entire database 16, or a portion of database 16 (which may be defined by individual tables, views, indexes or other logical or physical partitions of database 16). Likewise, for non-database programs, system 10 may be utilized to compress all data contained within data storage device 18, or a predefined logical or physical portion of data contained within data storage device 18.

To compress data of database 16 or data storage device 18, a user may indicate to system 10 which data should be converted. Then, system 10 can either perform the data conversion online or offline. With offline data conversion, logical data pages 22 are scanned and compressed page by page always storing the last compressed page position into a configuration file. The last compressed position is stored so that the conversion process can be reversed even in the event it is stopped or failed before completion. As logical data pages 22 are scanned, any data pages (logical data pages 22) that cannot fit into the space provided in physical file 24 are spilled over into overflow file 26. Online conversion requires that a pointer is maintained and honored for all intercepted operations and APIs such that it can be determined whether or not to compress or uncompress data based on the position of the requested operation.

System 10 may also be utilized to examine an existing database 16 or data storage device 18 to determine a suitable compression ratio for same, or to suggest higher compression ratios for particular logical partitions of database 16 or data storage device 18. This examination function may also be used to apply a compression ratio to copy an existing database 16, or portion thereof, to compressed data files (physical files 24) with fixed length block sizes equivalent to the original block (logical data page blocks 22) size reduced by the compression ratio.

The present invention therefore provides a useful system, method and/or computer program for reducing disk space usage and/or improving I/O performance of computer systems through the use of data compression and mapping of logical data page blocks to reduced size physical data file blocks. The system preferably intercepts write/read activity to a data storage device consisting of a logical data page of fixed length, compresses the logical data page to a size that is a divisor of the logical data page size, and then passes the compressed data page to a computer I/O subsystem where it is written to a fixed length physical data file block of the same size as the compressed logical data page. By using system 10, sector alignment is maintained on the data storage device such that high performance unbuffered I/O can still be used. In this way, the write order of the file blocks within a database file is maintained, as is a one-to-one correspondence of compressed data blocks to logical data pages.

While this invention has been described in connection with specific embodiments thereof, it will be understood that it is capable of further modification(s). The present invention is intended to cover any variations, uses or adaptations of the invention following in general, the principles of the invention and including such departures from the present disclosure as come within known or customary practice within the art to which the invention pertains and as may be applied to the essential features hereinbefore set forth.

Finally, as the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. Various modifications and equivalent arrangements are intended to be included within the spirit and scope of the invention and the appended claims. Therefore, the specific embodiments are to be understood to be illustrative of the many ways in which the principles of the present invention may be practiced.

What is claimed is:

1. A method for reducing disk space usage and/or improving I/O performance of a computer system, said method including the step of:
mapping logical data pages to physical file data blocks of lesser fixed block size on a one-to-one basis in a predetermined ordered manner.

2. The method as claimed in claim 1, wherein said physical file data blocks include all of said physical file data blocks of a data storage device or at least one predefined logical or physical portion of said data storage device

3. The method of claim 1, wherein said step of mapping logical data pages includes the steps of:
intercepting write I/O activity of a database and/or any other suitable device and compressing said logical data pages with any suitable compression application or algorithm to the size of said physical file data blocks of lesser fixed block size than said logical data pages; and/or
intercepting read I/O activity of said database and/or said any other suitable device and decompressing said physical file data blocks of lesser fixed block size with any suitable decompression application or algorithm to logical data pages.

4. The method of claim 3, wherein at least one of said steps of compressing said logical data pages or decompressing said physical file data blocks occurs asynchronously to normal data processing.

5. The method of claim 3, further including the step of writing incompressible logical data pages, or excess compressible logical data pages that could not fit into said physical file data blocks, into an overflow file while maintaining logical mapping via the use of pointers.

6. The method of claim 3, wherein said method is implemented on said computer system as either:
a software module linked with an I/O subroutine of said database and/or any other suitable device, or
a software device driver in an operating system configured for use with at least one data storage device connected to, or associated with, said computer system.

7. The method of claim 3, wherein at least one of said physical file data blocks are converted to a physical file while maintaining the order of said physical file data blocks, wherein said physical file is of reduced size to an original file, said original file comprised of said logical data pages.

8. The method of claim 7, wherein said physical file data blocks are defined by individual tables, views, indexes, and/or any other suitable logical or physical partitions of said database.

9. The method of claim 3, with the additional step of examining said database and/or said any other suitable device to determine a suitable compression ratio for same, or to suggest a higher compression ratio for one or more particular logical or physical partitions of said database and/or said any other suitable device.

10. The method of claim 9, wherein said examination step is also used to apply a compression ratio to copy an existing database, or portion thereof, to compressed data files with fixed length block sizes equivalent to the original block size reduced by said compression ratio.

11. A method for reducing disk space usage and/or improving I/O performance of a computer system, said computer system having at least one disk and a database application installed thereon, said method including the steps of:
handling write activity, said handling write activity comprising:
intercepting database write activity to said disk consisting of a data page of fixed length;
compressing said data page to a size that is a divisor of said data page fixed length; and
passing the compressed data page to an I/O subsystem of said computer system where said compressed data page is written to a fixed length data file block of the same size as said compressed data page; and/or
handling read activity, said handling read activity comprising:
intercepting database read activity from said disk;
decompressing said compressed data pages from said fixed length data file block to said data page of fixed length; and
passing said data page of fixed length to said database for normal processing.

12. The method of claim 11, wherein sector alignment is maintained on said disk such that no buffer is required for high performance I/O.

13. The method of claim 11, wherein:
write order of said fixed length data file blocks within said database is maintained; and
a one-to-one correspondence of said compressed data pages to said data pages is maintained.

14. A tangible machine readable medium storing a set of instructions that, when executed by a machine, cause the machine to execute a method for reducing disk space usage and/or improving I/O performance of said machine, said machine having at least one disk and a database application installed thereon, said method comprising the step of mapping logical data pages to physical file data blocks of lesser fixed block size on a one-to-one basis in a predetermined ordered manner.

15. The medium of claim 14, said method including the steps of:
handling write activity, said handling write activity comprising:
intercepting database write activity to disk consisting of a data page of fixed length;
compressing said data page to a size that is a divisor of said fixed length of said data page; and
passing the compressed data page to an I/O subsystem of said machine where it is then written to a fixed length data file block of the same size as said compressed data page; and/or
handling read activity, said handling read activity comprising:
intercepting database read activity from said disk;
decompressing said compressed data pages from said fixed length data file block to said data page of fixed length; and
passing said data page of fixed length to said database for normal processing.

16. The method of claim 15, wherein at least one of said steps of compressing said logical data pages or decompressing said physical file data blocks occurs asynchronously to normal data processing.

17. The method of claim 15, further including the step of writing incompressible logical data pages, or excess compressible logical data pages that could not fit into said physical file data blocks, into an overflow file while maintaining logical mapping via the use of pointers.

18. The method of claim 15, wherein said method is implemented on said computer system as either:
a software module linked with an I/O subroutine of said database and/or any other suitable device, or
a software device driver in an operating system configured for use with at least one data storage device connected to, or associated with, said computer system.

19. The method of claim 15, wherein at least one of said physical file data blocks are converted to a physical file while maintaining the order of said physical file data blocks, said physical file of reduced size to an original file, said original file comprised of said logical data pages.

20. The method as claimed in claim 14, wherein said physical file data blocks include all of said physical file data blocks of a data storage device or at least one predefined logical or physical portion of said data storage device.
